(19) United States
(12) Patent Application Publication
(10) Pub. No.: US 2008/0257186 A1
(43) Pub. Date: Oct. 23, 2008

(54) DRYING APPARATUS FOR SHEET

(75) Inventor: Akehiro KUSAKA, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 12/061,767

(22) Filed: Apr. 3, 2008

(30) Foreign Application Priority Data
Apr. 6, 2007 (JP) 2007-100429
Mar. 13, 2008 (JP) 2008-063569

(51) Int. Cl. B41F 35/00

(52) U.S. Cl. 101/424.1

(57) ABSTRACT

In a printing press equipped with a UV lamp for drying UV ink printed on a sheet transported by a transfer cylinder and a delivery cylinder, the UV lamp is accommodated within each of the transfer cylinder and the delivery cylinder, and is supported to be non-pivotable with respect to frames and immovable in the axial direction of the cylinder when the printing press is in operation.

### BACKGROUND OF THE INVENTION

1. Field of the Invention

This invention relates to a drying apparatus for a sheet in a printing press or a coating device which has the drying apparatus for drying a liquid, such as ink or varnish, supplied to the sheet.

2. Description of the Related Art

As this type of drying apparatus, those shown in FIGS. 17 and 18, for example, are present.

The one shown in FIG. 17 is called an interdeck system, which is an apparatus for drying the printed surface of a sheet of paper (hereinafter referred to as a sheet) immediately after being printed between an impression cylinder and a blanket cylinder by a UV lamp provided at a position opposing the impression cylinder of each of six-color printing units each comprising a plate cylinder, the blanket cylinder and the impression cylinder. The one shown in FIG. 18 is called a drying unit system, which is an apparatus having a drying unit including a transport cylinder and a UV lamp provided at a position opposing the transport cylinder, the drying unit being dedicated to drying and provided separately from the six-color printing units, and the apparatus being designed to dry the printed surface of a sheet printed between the impression cylinder and the blanket cylinder of each of the first printing unit to the fourth printing unit by the UV lamp of the drying unit provided downstream, in the sheet transport direction, of the first printing unit to the fourth printing unit.

JP-A-2004-99314 is an example of a related art document showing the above type of drying apparatus.

With a printing press as shown in FIG. 17, the overall length of the printing press can be shortened, and the printed surface of the sheet can be printed and then immediately dried by the UV lamp, in comparison with a printing press as shown in FIG. 18. However, the disadvantage arises that ultraviolet radiation thrown onto the printed surface (surface of the impression cylinder) is reflected to cure UV ink (ultraviolet curing ink) on the blanket.

In the printing press shown in FIG. 18, on the other hand, the drying apparatus is the drying unit dedicated to drying, and is thus free from the disadvantage of curing the UV ink on the blanket. However, the disadvantage is caused that compared with the printing press shown in FIG. 17, the overall length of the printing press is increased, and the printed surface of the sheet printed by any of the first printing unit to the fourth printing unit is scratched by a transfer cylinder provided between the impression cylinders before the UV ink is dried. That is, the UV ink is peeled and deposited on the circumferential surface of the transfer cylinder, and this peeled UV ink smears the printed surface of the succeeding sheet. Such a problem occurs similarly in a coating device which supplies UV varnish to a sheet.

The present invention has been conceived in light of the above-described circumstances. It is an object of the invention to provide a drying apparatus for a sheet, which can shorten the overall length of a machine to achieve cost reduction, prevents adverse influence due to the reflection of light thrown, and has a high drying ability.

### SUMMARY OF THE INVENTION

A first aspect in accordance with the present invention is a drying apparatus for a sheet, including drying means which opposes a printed surface or a coated surface of the sheet printed by a printing section or coated by a coating section to dry the printed surface or the coated surface of the sheet, comprising: a transport cylinder having sheet holding means for receiving the sheet immediately after being printed by the printing section or coated by the coating section, wherein the drying means is disposed within the transport cylinder in such a manner as to oppose the printed surface or the coated surface of the sheet held by the sheet holding means of the transport cylinder.

According to a second aspect of the present invention, the sheet may be guided by a plurality of sheet guide members provided with spacing in an axial direction of the transport cylinder, an outer peripheral surface of each of the sheet guide members being supported by the transport cylinder while extending in a rotating direction of the transport cylinder.

According to a third aspect of the present invention, the drying apparatus for a sheet may further comprise air means for bringing the sheet along the outer peripheral surface of each of the sheet guide members.

According to a fourth aspect of the present invention, the air means may be air blowing means, and the air blowing means may oppose each of the sheet guide members and eject air toward each of the sheet guide members.

According to a fifth aspect of the present invention, a plurality of the air blowing means may be provided to be arranged along a locus of movement of the sheet holding means in accordance with rotation of the transport cylinder.

According to a sixth aspect of the present invention, the sheet guide members may be supported to be movable in the axial direction of the transport cylinder.

According to a seventh aspect of the present invention, the drying means may be supported to be movable in an axial direction of the transport cylinder.

According to an eighth aspect of the present invention, the drying means can be detached laterally of the transport cylinder.

According to a ninth aspect of the present invention, the transport cylinder may be rotatably supported by a frame, and the drying means may be supported not to be rotatable with respect to the frame.

According to a tenth aspect of the present invention, the transport cylinder may comprise a pair of hollow shaft members rotatably supported by a pair of the frames, a connecting member supported between the pair of hollow shaft members and constituting the sheet holding means, and drive transmission means provided on at least one of the pair of shaft members for transmitting drive to the transport cylinder, and the drying means may be provided between the pair of shaft members, and opposing the printed surface or the coated surface of the sheet held by the sheet holding means of the transport cylinder to dry the printed surface or the coated surface of the sheet.

According to an eleventh aspect of the present invention, the drying means may be a UV lamp for drying the printed surface or the coated surface of the sheet, and a cover having an opening on a side of the UV lamp opposing the printed surface or the coated surface of the sheet may be provided.

According to a twelfth aspect of the present invention, the drying apparatus for a sheet may further comprise: a first guide member fixed to a frame side and extending along the axial direction of the transport cylinder; a second guide member fixed to the drying means, which dries the printed surface or the coated surface of the sheet, and extending along the axial direction of the transport cylinder; and a third guide member engaging the first guide member and the second guide member, extending along the axial direction of the transport cylinder, supported by the first guide member, and supporting the second guide member.

According to a thirteenth aspect of the present invention, the drying apparatus for a sheet may further comprise air ejection means provided along a locus of movement of the sheet holding means in accordance with rotation of the transport cylinder, and adapted to eject air toward opposite end portions, in an axial direction of the transport cylinder, of the sheet transported by the transport cylinder.

According to a fourteenth aspect of the present invention, the drying apparatus for a sheet may further comprise heat release means for releasing heat generated within the transport cylinder to an outside.

According to a fifteenth aspect of the present invention, the transport cylinder may be rotatably supported by a frame, and the drying means may be supported to be rotatable, where necessary, with respect to the frame independently of rotation of the transport cylinder.

According to a sixteenth aspect of the present invention, the drying apparatus for a sheet may further comprise interference prevention means which moves the drying means from a position in proximity to the sheet to a position spaced from the sheet in a radial direction of the transport cylinder when the drying means opposes the sheet holding means of the transport cylinder, thereby preventing interference of the drying means with the sheet holding means.

According to a seventeenth aspect of the present invention, the drying apparatus for a sheet may further comprise: a sheet guide member opposing the transport cylinder and provided along a locus of movement of the sheet holding means of the transport cylinder to guide the sheet transported by the transport cylinder; and sheet moving means for bringing the sheet transported by the transport cylinder into contact with an outer peripheral surface of the sheet guide member.

According to an eighteenth aspect of the present invention, the sheet moving means may be air blowing means provided within the transport cylinder, and the air blowing means may oppose the sheet guide member and eject air toward the sheet guide member, thereby bringing the sheet held by the sheet holding means into contact with the outer peripheral surface of the sheet guide member.

According to the drying apparatus for a sheet concerned with the present invention, the drying means is accommodated within the transport cylinder. Thus, it becomes possible to constitute a printing press or a coating device which has a high drying ability, can reduce leakage of light and exerts no adverse influence on anything other than the sheet, without increasing the overall length of the machine.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a general schematic configurational drawing of a printing press showing Embodiment 1 of the present invention;

FIG. 2 is a side sectional view of a transfer cylinder in the printing press;

FIG. 3 is a front sectional view of the transfer cylinder;

FIG. 4 is a plan view of the transfer cylinder;

FIGS. 5(a), 5(b) and 5(b) are explanation drawings of a slide rail;

FIG. 6 is a side sectional view of a transfer cylinder showing Embodiment 2 of the present invention;

FIG. 7 is a front sectional view of the transfer cylinder;

FIG. 8 is a plan view of the transfer cylinder;

FIG. 9 is a plan view of an air guide;

FIG. 10 is a side sectional view of a transfer cylinder showing Embodiment 3 of the present invention;

FIG. 11 is an explanation drawing of a swinging mechanism;

FIG. 12 is a front sectional view of the transfer cylinder;

FIG. 13 is a general schematic configurational drawing of a printing press showing Embodiment 4 of the present invention;

FIG. 14 is a side sectional view of a transfer cylinder in the printing press;

FIG. 15 is a front sectional view of the transfer cylinder;

FIG. 16 is a plan view of the transfer cylinder;

FIG. 17 is an explanation drawing of a drying apparatus in a printing press as a conventional example; and

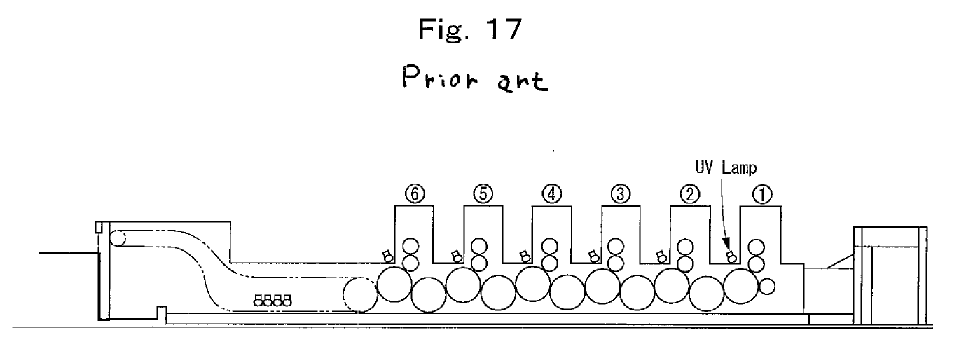

FIG. 18 is an explanation drawing of a drying apparatus in a printing press as a different conventional example.

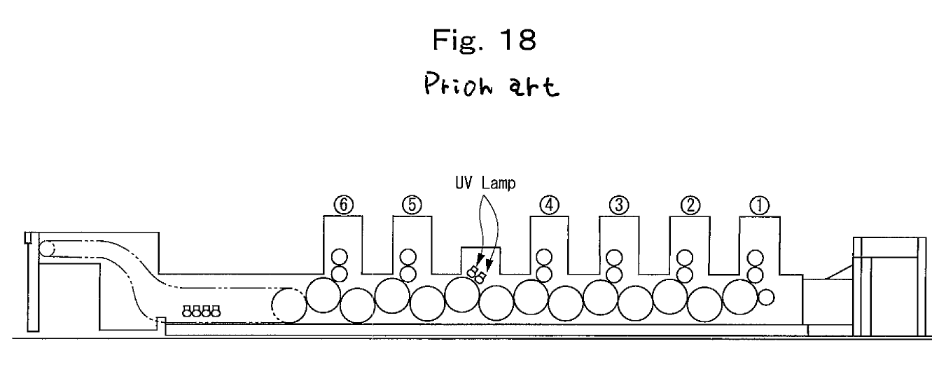

### DETAILED DESCRIPTION OF THE INVENTION

A drying apparatus for a sheet according to the present invention will be described in detail by embodiments with reference to the accompanying drawings.

### Embodiment 1

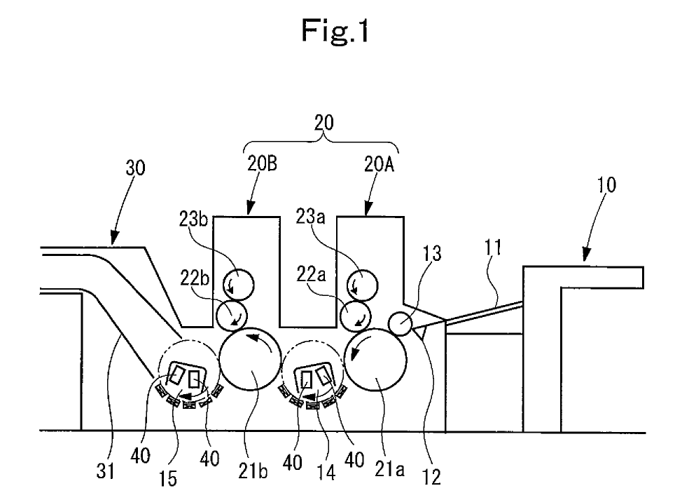

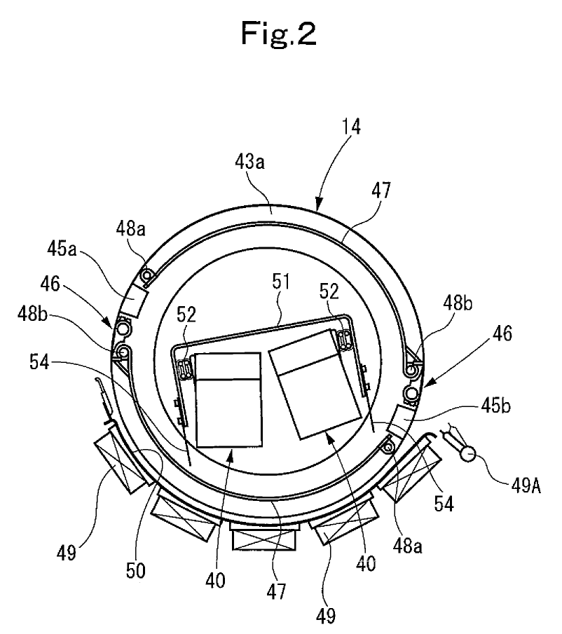

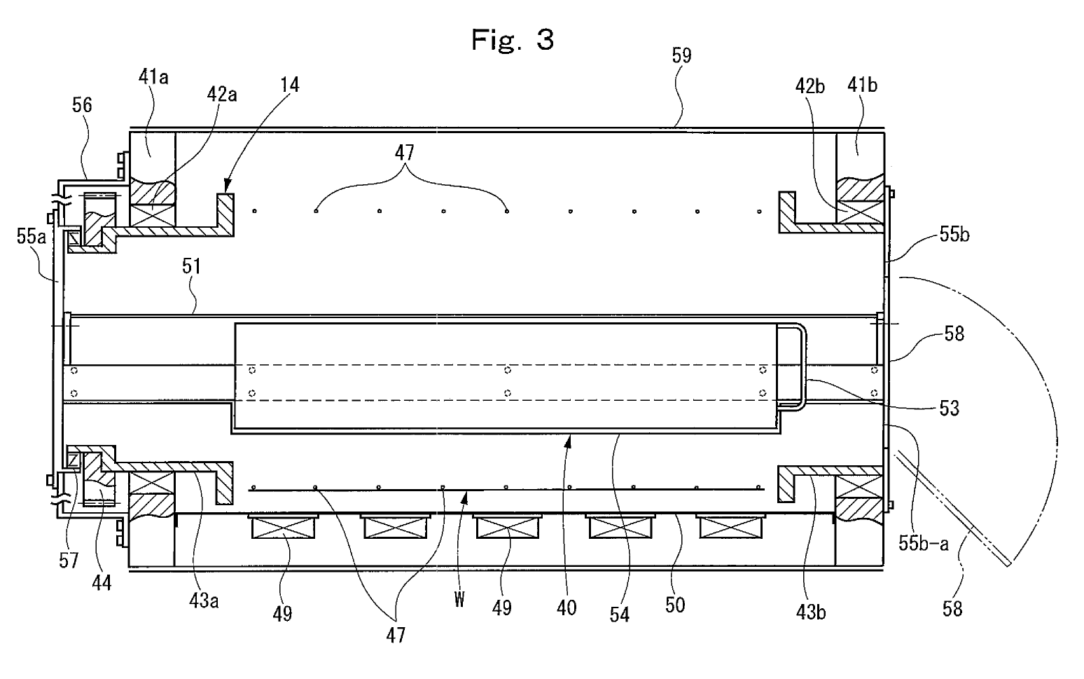

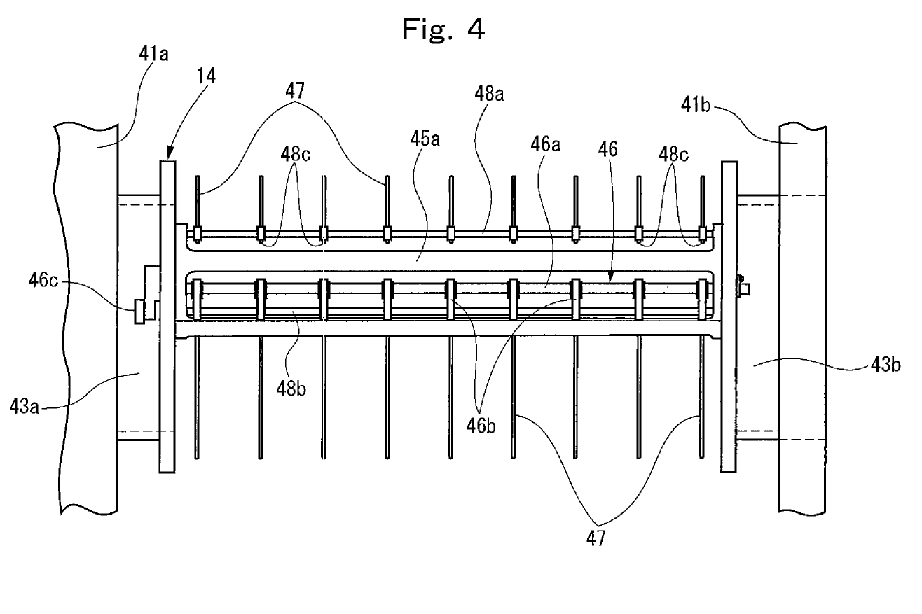

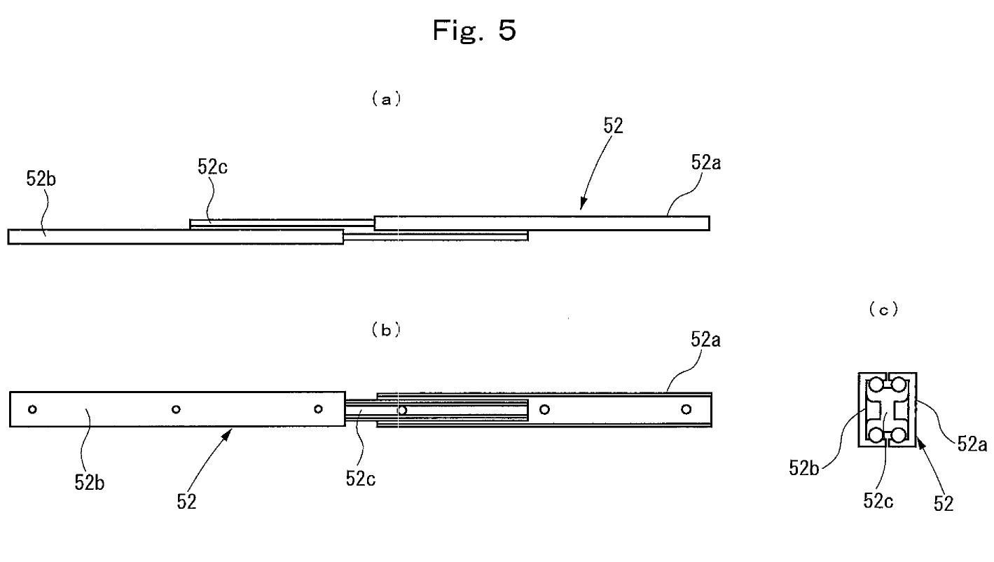

FIG. 1 is a general schematic configurational drawing of a printing press showing Embodiment 1 of the present invention. FIG. 2 is a side sectional view of a transfer cylinder in the printing press. FIG. 3 is a front sectional view of the transfer cylinder. FIG. 4 is a plan view of the transfer cylinder. FIGS. 5(a), 5(b) and 5(b) are explanation drawings of a slide rail.

As shown in FIG. 1, a feeder board 11 for feeding sheets of paper (simply called sheets) on a pile (not shown) to a printing section 20 one by one is provided in a feeder 10. A swing arm shaft pregripper 12 for passing the sheet on to an impression cylinder 21a of a first offset printing unit 20A of the printing section 20 via an intermediate cylinder 13 is provided at the leading end of the feeder board 11.

A blanket cylinder 22a is in contact with the impression cylinder 21a of the first offset printing unit 20A at a portion downstream of the intermediate cylinder 13 in the rotating direction of the impression cylinder 21a. A plate cylinder 23a is in contact with the blanket cylinder 22a at a portion upstream of the impression cylinder 21a in the rotating direction of the blanket cylinder 22a. An ink supply device and a dampening device (not shown) are provided on a side of the plate cylinder 23a upstream of the blanket cylinder 22a in the rotating direction of the plate cylinder 23a.

A surface of the impression cylinder 21a downstream of the blanket cylinder 22a in the rotating direction of the impression cylinder 21a in the first offset printing unit 20A is in contact with an impression cylinder 21b of a second offset printing unit 20B via a transfer cylinder (transport cylinder) 14. The second offset printing unit 20B is equipped with a blanket cylinder 22b, a plate cylinder 23b, an ink supply device, a dampening device, etc., as is the first offset printing unit 20A.

A delivery cylinder (transport cylinder) 15 is in contact with a surface of the impression cylinder 21b downstream of the blanket cylinder 22b in the rotating direction of the impression cylinder 21b in the second offset printing unit 20B. The sheet printed by the first and second offset printing units 20A and 20B is transported from the delivery cylinder 15 to a delivery unit 30 by a delivery chain 31 passed over the delivery cylinder 15, whereafter the sheet is delivered onto a pile board (not shown).

The transfer cylinder 14 and the delivery cylinder 15 are each composed of a skeleton cylinder, and have two UV lamps (drying means) 40 accommodated inside for irradiating the printed surface of the sheet with ultraviolet radiation to dry ultraviolet curing ink.

In detail, the transfer cylinder 14, as shown in FIGS. 2 to 4, has left and right tubular flange portions (shaft members) 43a and 43b pivotably supported by left and right frames 41a and 41b via bearings 42a and 42b. A gear (drive transmission means) 44 integrally secured to the tubular flange portion 43a located on the drive side (left-hand side in FIG. 3) meshes with a gear train (not shown) so that the transfer cylinder 14 is rotationally driven in synchronism with the respective cylinders of the printing press.

Between the left and right tubular flange portions 43a and 43b, two stays (connecting members) 45a and 45b are installed at positions of point symmetry of the tubular flange portions 43a and 43b. Each of the stays 45a and 45b is provided with a gripper device (sheet holding means) 46, in which a plurality of grippers 46b are mounted with predetermined spacing on a gripper bar 46a extending in the lateral direction. By the opening and closing of these grippers 46b, the gripper device 46 receives the sheet W (see FIG. 3) from the impression cylinder 21a of the first offset printing unit 20A, and passes the sheet W on to the impression cylinder 21b of the second offset printing unit 20B. In FIG. 4, a cam follower 46c for opening and closing of the grippers 46b can follow the cam surface of a cam (not shown) interlocked to the printing press.

A plurality of arcuate rod-shaped guides (sheet guide members) 47 extending along the loci of rotation of the stays 45a, 45b (the outer peripheral portions of the transfer cylinder 14) are disposed with predetermined spacing in the cylinder axis direction in such a manner as to be arranged concentrically between the two stays 45a and 45b. The rod-shaped guides 47 have opposite end portions supported on support bars 48a and 48b installed between the left and right tubular flange portions 43a and 43b. The rod-shaped guides 47 can be moved on the support bars 48a, 48b in the cylinder axis direction, by loosening bolts 48c, in accordance with the imposition of printing products, namely, so that the mounting positions of the rod-shaped guides 47 can be adjusted in correspondence with the margin of the printed surface.

Many fans 49 for blowing air (i.e., air means or air blowing means) so that the sheet W is guided by the rod-shaped guides 47 are disposed along a lower half of the transfer cylinder 14 in the circumferential direction and the cylinder axis direction. These fans 49 in combination with the rod-shaped guides 47 constitute a guide device for the sheet W. In FIGS. 2 and 3, a support plate 50 is installed between the left and right frames 41a and 41b to support the many fans 49. In FIG. 2, reference numeral 49A denotes an air lowing nozzle.

A support case 51 having a channel-shaped cross-section is transversely installed, with its open portion directed downward, within the transfer cylinder 14 in such a manner as to penetrate the space between the left and right tubular flange portions 43a and 43b. The support case 51 has opposite end portions secured to end plates 55a and 55b. The left end plate 55a permits the rotation of the tubular flange portion 43a via an oil seal 57, and is fixed to the frame 41a via a tubular bracket 56. On the other hand, the right end plate 55b is directly fixed to the frame 41b, and is provided with a lid member 58 for opening and closing an opening portion 55b-a through which the UV lamp 40 is entered and removed.

The two UV lamps 40 are supported within the support case 51 to be slidable in the axial direction of the transfer cylinder 14 via slide rails 52. These UV lamps 40 are mounted to be pointed downward so as to be capable of throwing ultraviolet radiation downwardly. Moreover, these UV lamps 40 can be withdrawn, where necessary, rightward in FIG. 3 (i.e., to the work side) to the outside of the printing press via handles 53. In FIG. 2, light blocking plates 54 are annexed to both sides in the front-to-back direction of the support case 51 (i.e., a direction perpendicular to the axial direction of the transfer cylinder 14) to prevent leakage of ultraviolet radiation.

The slide rail 52, as shown in FIGS. 5(a) to 5(c), comprises a movable rail (second guide member) 52a secured to the UV lamp 40, a stationary rail (first guide member) 52b secured to the support case 51, an intermediate rail (third guide member) 52c slidably fitted to both of the movable rail 52a and the stationary rail 52b. When maximally extended, the slide rail 52 can extend out by an amount which is the sum of the lengths of the movable rail 52a and most of the intermediate rail 52c.

In FIG. 3, reference numeral 59 denotes a step of the printing press. The UV lamp (drying means) 40 in the delivery cylinder 15 is provided in the same configuration as that in the transfer cylinder 14. Thus, its explanation will be omitted here by reference to the above descriptions.

The actions of the printing press according to the present embodiment constituted as above will be described below.

The sheets W dispatched, one by one, from the feeder 10 onto the feeder board 11 are passed by the swing arm shaft pregripper 12 on to the impression cylinder 21a of the first offset printing unit 20A of the printing section 20 via the intermediate cylinder 13. Separately, the plate cylinder 23a is supplied with ink from the ink supply device of the first offset printing unit 20A, and dampening water from the dampener of the first offset printing unit 20A. The blanket cylinder 22a supplied with the ink from the plate cylinder 23a and the sheet W held on the impression cylinder 21a are brought into contact to print the sheet W in a first color.

Then, the sheet W is passed on to the impression cylinder 21b of the second offset printing unit 20B via the transfer cylinder 14 to print the sheet W in a second color in the second offset printing unit 20B, as in the first offset printing unit 20A. Then, the sheet W is passed on to the delivery chain 31 via the delivery cylinder 15 for transport to the delivery unit 30, and is then delivered.

During this process, the ink of the first color printed in the first offset printing unit 20A is dried by the two UV lamps 40 accommodated inside the transfer cylinder 14, while the ink of the second color printed in the second offset printing unit 20B is similarly dried by the two UV lamps 40 accommodated inside the delivery cylinder 15.

That is, with the transfer cylinder 14 and the delivery cylinder 15, the sheet W having a front end portion gripped by the grippers 46b of the gripper device 46 is blown upward by air blown out of the many fans 49, and transported so as to be guided by the plurality of rod-shaped guides 47. On this occasion, the sheet W has the printed surface irradiated with ultraviolet radiation applied downward from the UV lamps 40, whereby the ultraviolet curing inks are dried.

In this manner, according to the present embodiment, the two UV lamps 40 are accommodated within the transfer cylinder 14 and the delivery cylinder 15. Thus, the drying ability can be enhanced in comparison with the single UV lamp 40, and there is no need to provide the dedicated unit as stated earlier. Hence, an intermediate position of drying can be set at an arbitrary position in the printing section 20 or the like. Furthermore, the overall length of the machine can be shortened, and cost reduction can be achieved.

According to the present embodiment, the two UV lamps 40 throw ultraviolet rays downward, and the regions above them and lateral to them are covered with the support case 51 and the light blocking plates 54. Thus, ultraviolet radiation does not leak to a region in the vicinity of the site of contact (printing) between the impression cylinder 21a or 21b and the blanket cylinder 22a or 22b, which is a region located in a direction reverse to the direction of irradiation by the UV lamps 40. This avoids the disadvantage of curing the ultraviolet curing inks on the blankets of the blanket cylinders 22a, 22b. Besides, the two UV lamps 40 are used in a fixed state while the printing press is in operation. Thus, an energy saving can be realized, resulting in cost reduction.

According to the present embodiment, the sheet W is blown upward by air blown out of the many fans 49, and transported so as to be guided by the plurality of rod-shaped guides 47. Thus, the printed surface can be brought as close as possible to the UV lamps 40, leading to the advantage that the drying ability is even more enhanced.

According to the present embodiment, moreover, the UV lamp 40 as a whole can be withdrawn, where necessary, to the outside of the printing press to the right in FIG. 3 (i.e., the work side) via the slide rail 52. This confers the advantage that maintenance of the UV lamp 40 can be performed easily.

### Embodiment 2

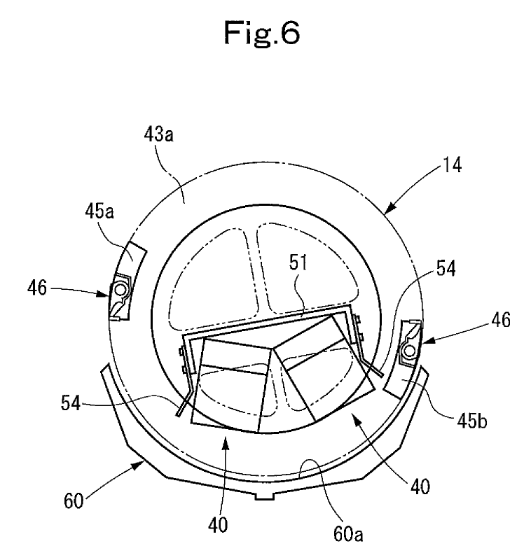

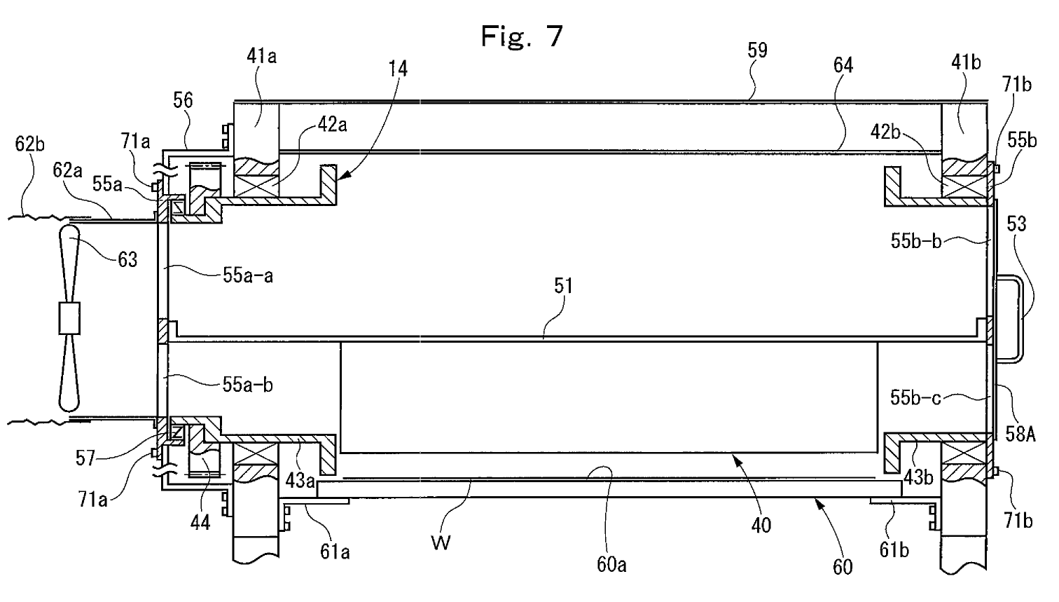

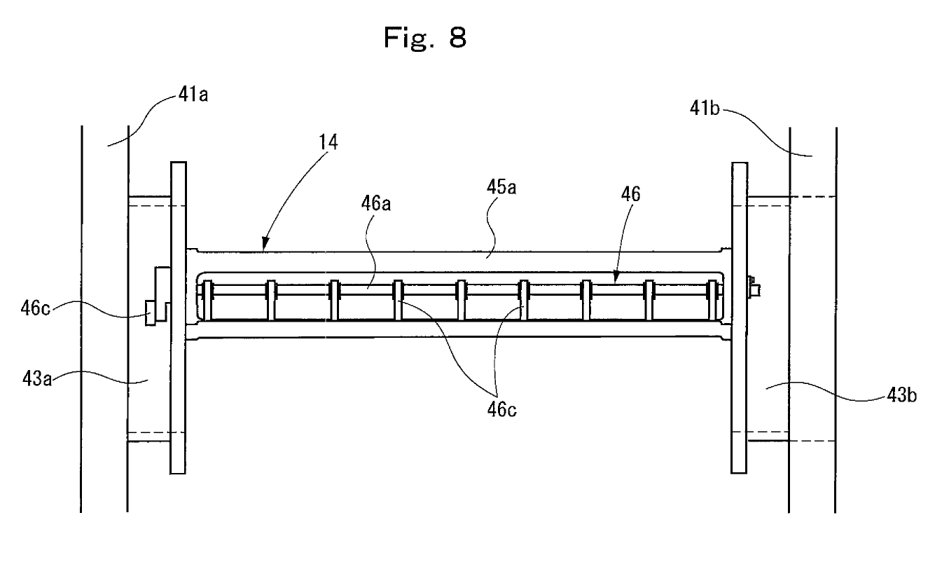

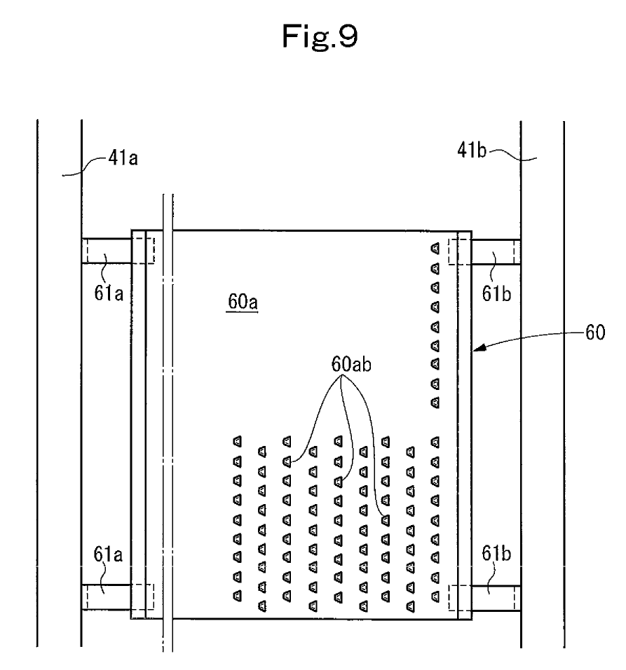

FIG. 6 is a side sectional view of a transfer cylinder showing Embodiment 2 of the present invention. FIG. 7 is a front sectional view of the transfer cylinder. FIG. 8 is a plan view of the transfer cylinder. FIG. 9 is a plan view of an air guide.

In Embodiment 2, ventilation holes 55a-a, 55a-b and 55b-b, 55b-c are formed, respectively, in the end plates 55a and 55b annexed to the opposite end portions of the support case 51. Ducts 62a, 62b equipped with a fan (heat release means) 63 are connected to the left end plate 55a in FIG. 7, while a filter 58A furnished with a handle 53 is annexed to the right end plate 55b in FIG. 7 so as to close the ventilation holes 55b-b, 55b-c. In this configuration, air which has been taken in through the ventilation holes 55b-b, 55b-c is sucked into the ducts 62a, 62b through the ventilation holes 55a-a, 55a-b by the fan 63 to air-cool the UV lamps 40.

During maintenance of the UV lamp 40, bolts 71a for fixing the end plate 55a to the tubular bracket 56, and bolts 71b for fixing the end plate 55b to the frame 41b are detached, and the handle 53 integrally attached to the end plate 55b via the filter 58A is rotated to invert the UV lamp 40 together with the support case 51 so that a maintenance operation can be performed from above the step 59. In FIG. 7, reference numeral 64 denotes a light blocking cover provided directly below the step 59.

Further, the guide device composed of the rod-shaped guides 47 and the fans 49 in Embodiment 1 is replaced by an air guide (air means, air blowing means) 60 which is secured to the left and right frames 41a and 41b via brackets 61a and 61b, as shown in FIG. 9. The air guide 60 has a guide plate 60a comprising an arcuate plate extending along the locus of rotation of the gripper device 46 of the transfer cylinder 14. The guide plate 60a has many air gushing holes 60ab formed therein. These air gushing holes 60ab are bored such that air flows rightward and leftward symmetrically with respect to the center of the guide plate 60a (i.e., air flows in the sheet width direction of the sheet W) along the guide surface of the guide plate 60a. The air guide 60 has already been rendered known to the public by the document JP-A-2004-99314 filed by the applicant of the present application. Thus, its concrete configuration is to be referred to this document, and a relevant detailed description is omitted herein.

Other features are the same as those in Embodiment 1. Thus, the same members as those in FIGS. 2 to 4 will be assigned same reference numerals as those indicated in these drawings, and duplicate explanations are omitted.

In the present embodiment as well, the same actions and effects as those in Embodiment 1 are obtained.

### Embodiment 3

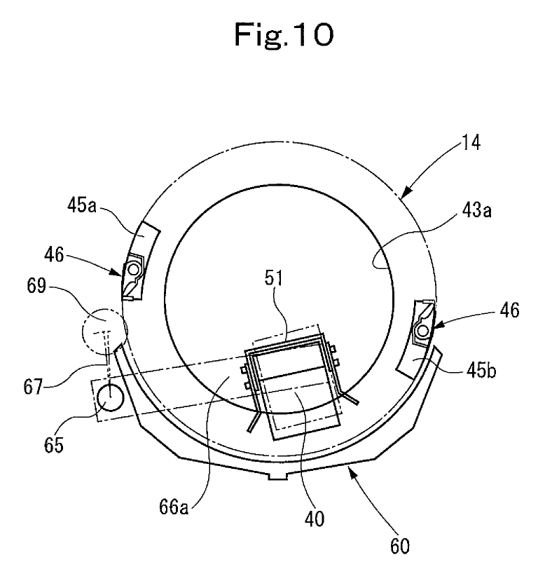

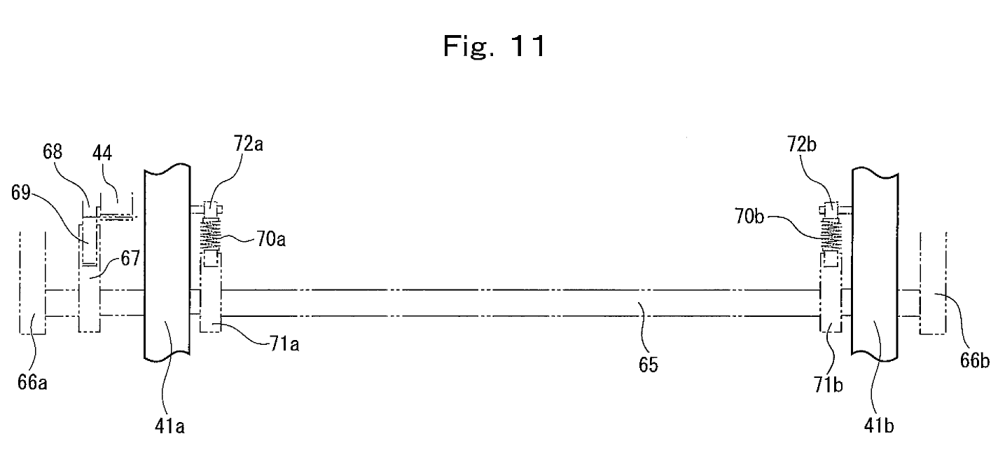

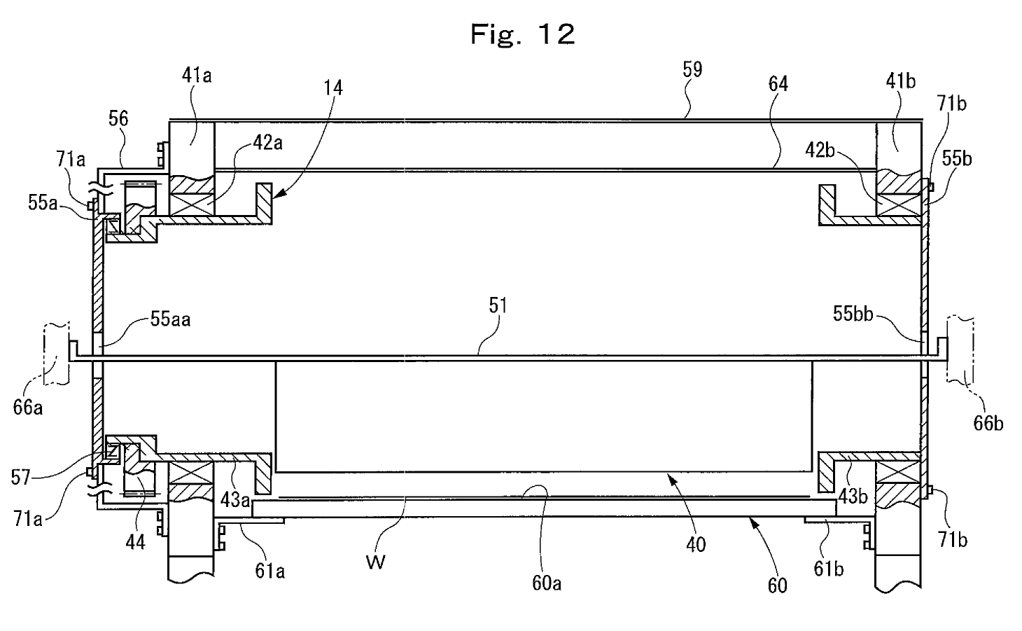

FIG. 10 is a side sectional view of a transfer cylinder showing Embodiment 3 of the present invention. FIG. 11 is an explanation drawing of a swinging mechanism. FIG. 12 is a front sectional view of the transfer cylinder.

To support the UV lamp 40 in Embodiment 2 swingably, proximal end portions of levers 66a and 66b are secured to the opposite ends of a support bar 65 which penetrates the left and right frames 41a and 41b pivotably. Leading end portions of these levers 66a and 66b are secured to opposite end portions of the support case 51 which protrude from inside the transfer cylinder 14 through through-holes 55aa, 55bb of the end plates 55a, 55b.

The UV lamp 40 is retreated inwardly within the transfer cylinder 14 at a desired time (see a dashed double-dotted line in FIG. 10) by a swinging mechanism (interference prevention means) so that the UV lamp 40 does not interfere with the gripper device 46 of the transfer cylinder 14, the swinging mechanism comprising an arm 67 secured to a left end portion of the support bar 65 in FIG. 11, a cam follower 69 rotatably supported by the leading end of the arm 67, and a cam 68 secured to the side surface of the gear 44 and followed by the cam follower 69. In FIG. 11, return springs 70a, 70b are interposed between stoppers 71a, 71b secured to the support bar 65 and bearing members 72a, 72b secured to the frames 41a, 41b to return the UV lamp 40 from the position of retreat mentioned above (see a solid line in FIG. 10).

Other features are the same as those in Embodiment 2. Thus, FIGS. 6 to 9 are to be referred to for these features, and detailed explanations are omitted here.

In the present embodiment as well, the advantage that the UV lamp 40 can be brought as close as possible to the printed surface of the sheet W to render the drying ability even higher is obtained in addition to the same actions and effects as those in Embodiment 2.

### Embodiment 4

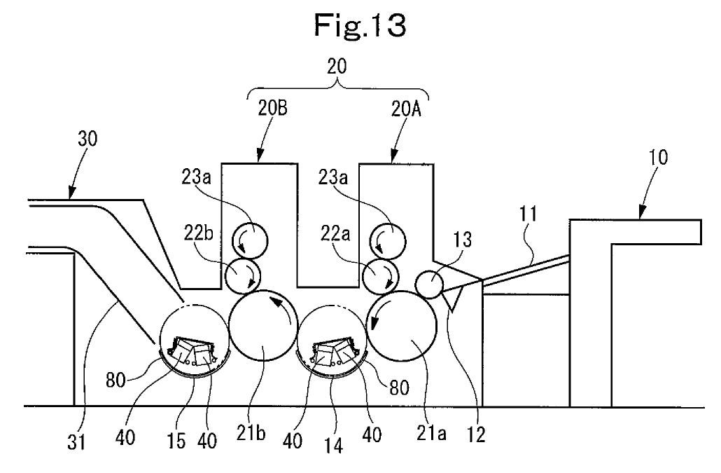

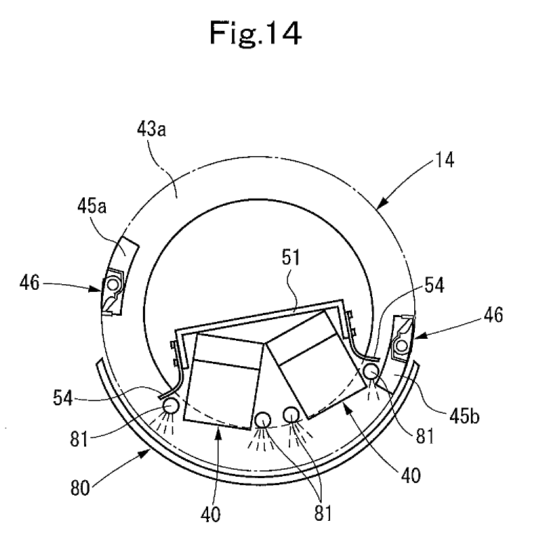

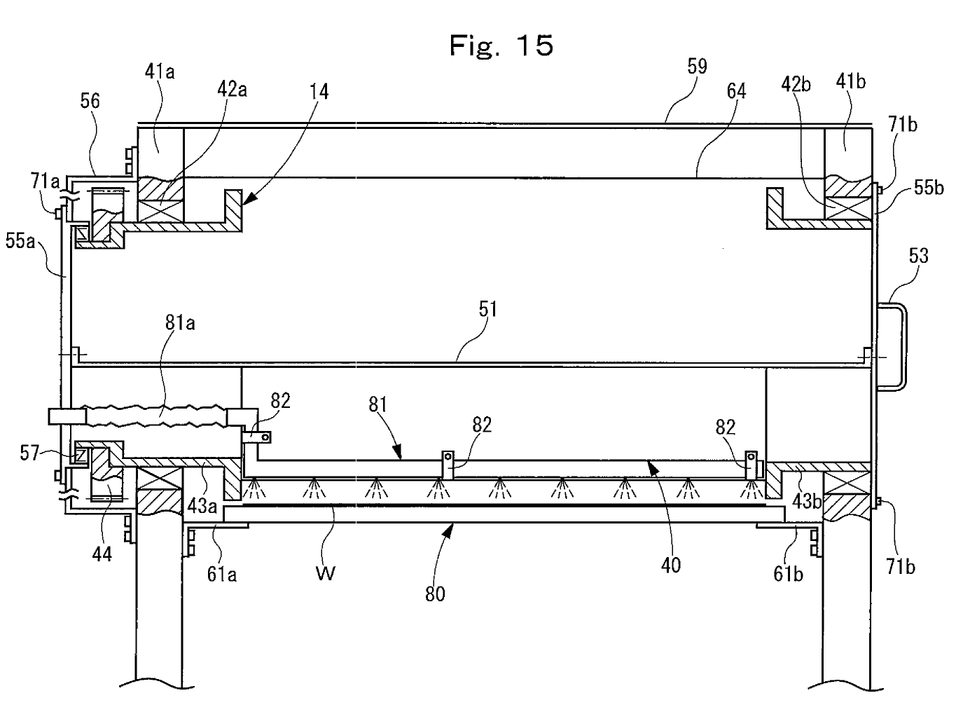

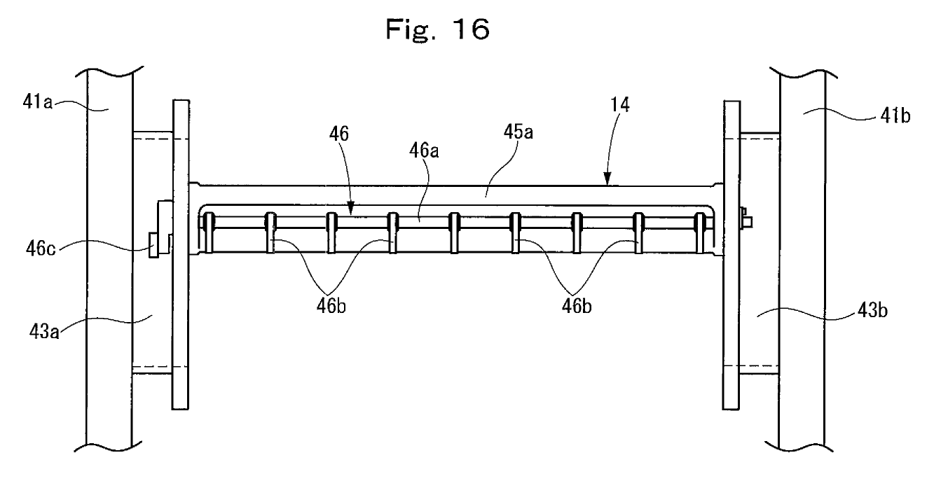

FIG. 13 is a general schematic configurational drawing of a printing press showing Embodiment 4 of the present invention. FIG. 14 is a side sectional view of a transfer cylinder in the printing press. FIG. 15 is a front sectional view of the transfer cylinder. FIG. 16 is a plan view of the transfer cylinder.

As shown in FIG. 13, a feeder board 11 for feeding sheets of paper (simply called sheets) on a pile (not shown) to a printing section 20 one by one is provided in a feeder 10. A swing arm shaft pregripper 12 for passing the sheet on to an impression cylinder 21a of a first offset printing unit 20A of the printing section 20 via an intermediate cylinder 13 is provided at the leading end of the feeder board 11.

A blanket cylinder 22a is in contact with the impression cylinder 21a of the first offset printing unit 20A at a portion downstream of the intermediate cylinder 13 in the rotating direction of the impression cylinder 21a. A plate cylinder 23a is in contact with the blanket cylinder 22a at a portion upstream of the impression cylinder 21a in the rotating direction of the blanket cylinder 22a. An ink supply device and a dampening device (not shown) are provided on a side of the plate cylinder 23a upstream of the blanket cylinder 22a in the rotating direction of the plate cylinder 23a.

A surface of the impression cylinder 21a downstream of the blanket cylinder 22a in the rotating direction of the impression cylinder 21a in the first offset printing unit 20A is in contact with an impression cylinder 21b of a second offset printing unit 20B via a transfer cylinder (transport cylinder) 14. The second offset printing unit 20B is equipped with a blanket cylinder 22b, a plate cylinder 23b, an ink supply device, a dampening device, etc., as is the first offset printing unit 20A.

A delivery cylinder (transport cylinder) 15 is in contact with a surface of the impression cylinder 21b downstream of the blanket cylinder 22b in the rotating direction of the impression cylinder 21b in the second offset printing unit 20B. The sheet printed by the first and second offset printing units 20A and 20B is transported from the delivery cylinder 15 to a delivery unit 30 by a delivery chain 31 passed over the delivery cylinder 15, whereafter the sheet is delivered onto a pile board (not shown).

The transfer cylinder 14 and the delivery cylinder 15 are each composed of a skeleton cylinder, and have two UV lamps (drying means) 40 accommodated inside for irradiating the printed surface of the sheet with ultraviolet radiation to dry ultraviolet curing ink.

In detail, the transfer cylinder 14, as shown in FIGS. 14 to 16, has left and right tubular flange portions (shaft members) 43a and 43b pivotably supported by left and right frames 41a and 41b via bearings 42a and 42b. A gear (drive transmission means) 44 integrally secured to the tubular flange portion 43a located on the drive side (left-hand side in FIG. 15) meshes with a gear train (not shown) so that the transfer cylinder 14 is rotationally driven in synchronism with the respective cylinders of the printing press.

Between the left and right tubular flange portions 43a and 43b, two stays (connecting members) 45a and 45b are installed at positions of point symmetry of the tubular flange portions 43a and 43b. Each of the stays 45a and 45b is provided with a gripper device (sheet holding means) 46, in which a plurality of grippers 46b are mounted with predetermined spacing on a gripper bar 46a extending in the lateral direction. By the opening and closing of these grippers 46b, the gripper device 46 receives the sheet W (see FIG. 15) from the impression cylinder 21a of the first offset printing unit 20A, and passes the sheet W on to the impression cylinder 21b of the second offset printing unit 20B. In FIG. 16, a cam follower 46c for opening and closing of the grippers 46b can follow the cam surface of a cam (not shown) interlocked to the printing press.

A paper guide (sheet guide member) 80 is secured to the left and right frames 41a and 41b via brackets 61a and 61b. The paper guide 80 comprises an arcuate plate extending along the locus of rotation of the gripper device 46 of the transfer cylinder 14, and has a size enough to cover a nearly lower half portion of the transfer cylinder 14. The paper guide 80 may be a plurality of rod-shaped guides disposed in the paper width direction, as in Embodiment 1.

An air blowing nozzle pipe (air blowing means) 81 for pressing the sheet W onto the paper guide 80 by blowing is built in the transfer cylinder 14. Four of the air blowing nozzle pipes 81 are provided on front and rear side surfaces of UV lamps 40 (to be described later), while being supported by a suitable number of clamps 82, to eject air from multiple points in the paper width direction toward the paper guide 80. A left end side (in FIG. 15) of the air blowing nozzle pipe 81 has a flexible tube portion 81a suitably interposed halfway therethrough, is led outward through the left end plate 55a (in FIG. 15), and is connected to a pressurized air supply source (not shown).

A support case 51 having a channel-shaped cross-section is transversely installed, with its open portion directed downward, within the transfer cylinder 14 in such a manner as to penetrate the space between the left and right tubular flange portions 43a and 43b. The support case 51 has opposite end portions secured to the end plates 55a and 55b. In FIG. 15, the left end plate 55a permits the rotation of the tubular flange portion 43a via an oil seal 57, and is fixed to the frame 41a via a tubular bracket 56. On the other hand, the right end plate 55b in FIG. 15 is directly fixed to the frame 41b.

During maintenance of the UV lamp 40, bolts 71a for fixing the end plate 55a to the tubular bracket 56, and bolts 71b for fixing the end plate 55b to the frame 41b are detached, and a handle 53 integrally attached to the end plate 55b is rotated to invert the UV lamp 40 together with the support case 51 so that a maintenance operation can be performed from above a step 59. In FIG. 15, reference numeral 64 denotes a light blocking cover provided directly below the step 59.

The UV lamp (drying means) 40 in the delivery cylinder 15 is provided in the same configuration as in the transfer cylinder 14. Thus, its explanation will be omitted here by reference to the above descriptions.

The actions of the printing press according to the present embodiment constituted as above will be described below.

The sheets W dispatched, one by one, from the feeder 10 onto the feeder board 11 are passed by the swing arm shaft pregripper 12 on to the impression cylinder 21a of the first offset printing unit 20A of the printing section 20 via the intermediate cylinder 13. Separately, the plate cylinder 23a is supplied with ink from the ink supply device of the first offset printing unit 20A, and dampening water from the dampener of the first offset printing unit 20A. The blanket cylinder 22a supplied with the ink from the plate cylinder 23a and the sheet W held on the impression cylinder 21a are brought into contact to print the sheet W in a first color.

Then, the sheet W is passed on to the impression cylinder 21b of the second offset printing unit 20B via the transfer cylinder 14 to print the sheet W in a second color in the second offset printing unit 20B, as in the first offset printing unit 20A. Then, the sheet W is passed on to the delivery chain 31 via the delivery cylinder 15 for transport to the delivery unit 30, and is then delivered.

During this process, the ink of the first color printed in the first offset printing unit 20A is dried by the two UV lamps 40 accommodated inside the transfer cylinder 14, while the ink of the second color printed in the second offset printing unit 20B is similarly dried by the two UV lamps 40 accommodated inside the delivery cylinder 15.

That is, with the transfer cylinder 14 and the delivery cylinder 15, the sheet W having a front end portion gripped by the grippers 46b of the gripper device 46 is transported so as to be pressed against the paper guide 80 by air blown out of the air blowing nozzle pipes 81 at their multiple points. On this occasion, the sheet W has the printed surface irradiated with ultraviolet radiation applied downward from the UV lamps 40, whereby the ultraviolet curing inks are dried.

In this manner, according to the present embodiment, the two UV lamps 40 are accommodated within the transfer cylinder 14 and the delivery cylinder 15. Thus, the drying ability can be enhanced in comparison with the single UV lamp 40, and there is no need to provide the dedicated unit as stated earlier. Hence, the intermediate position of drying can be set at an arbitrary position in the printing section 20 or the like. Furthermore, the overall length of the machine can be shortened, and cost reduction can be achieved.

According to the present embodiment, the two UV lamps 40 throw ultraviolet rays downward, and the regions above them and lateral to them are covered with the support case 51 and the light blocking cover 64. Thus, ultraviolet radiation does not leak to a region in the vicinity of the site of contact (printing) between the impression cylinder 21a or 21b and the blanket cylinder 22a or 22b, which is a region located in a direction reverse to the direction of irradiation by the UV lamps 40. This avoids the disadvantage of curing the ultraviolet curing inks on the blankets of the blanket cylinders 22a, 22b. Besides, the two UV lamps 40 are used in a fixed state while the printing press is in operation. Thus, an energy saving can be realized, resulting in cost reduction.

According to the present embodiment, moreover, the advantage is obtained that during maintenance of the UV lamps 40, maintenance of the air blowing nozzle pipes 81 can also be performed at the same time.

While the present invention has been described by the above embodiments, it is to be understood that the invention is not limited to these embodiments, but may be varied in many other ways. For example, the diameters of the transfer cylinder 14 and the delivery cylinder 15 can be changed, and the number of the UV lamps 40 can be changed. In Embodiment 1, the fans 49, which are the air blowing means as the air means, are provided below the transfer cylinder 14, and air blown out of the fans 49 enables the sheet W to be guided by the rod-shaped guides 47 supported by the transfer cylinder 14. However, air suction means as the air means may be provided within the transfer cylinder 14, and air sucked into the air suction means may enable the sheet W to be guided by the rod-shaped guides 47 supported by the transfer cylinder 14. Furthermore, in Embodiment 2, heat is released to the outside by sucking air from inside the transfer cylinder 14 by means of the fan 63 as the heat release means. However, heat may be released to the outside by ejecting air. Besides, the present invention is not limited to the printing press, but can also be applied to a coating device which has a drying apparatus for drying varnish supplied to a sheet. Such variations are not to be regarded as a departure from the spirit and scope of the invention, and all such modifications as would be obvious to one skilled in the art are intended to be included within the scope of the appended claims.

1. A drying apparatus for a sheet, including drying means which opposes a printed surface or a coated surface of the sheet printed by a printing section or coated by a coating section to dry the printed surface or the coated surface of the sheet, comprising:
a transport cylinder having sheet holding means for receiving the sheet immediately after being printed by the printing section or coated by the coating section,
wherein the drying means is disposed within the transport cylinder in such a manner as to oppose the printed surface or the coated surface of the sheet held by the sheet holding means of the transport cylinder.

2. The drying apparatus for a sheet according to claim 1, wherein
the sheet is guided by a plurality of sheet guide members provided with spacing in an axial direction of the transport cylinder, an outer peripheral surface of each of the sheet guide members being supported by the transport cylinder while extending in a rotating direction of the transport cylinder.

3. The drying apparatus for a sheet according to claim 2, further comprising:
air means for bringing the sheet along the outer peripheral surface of each of the sheet guide members.

4. The drying apparatus for a sheet according to claim 3, wherein
the air means is air blowing means, and
the air blowing means opposes each of the sheet guide members and ejects air toward each of the sheet guide members.

5. The drying apparatus for a sheet according to claim 4, wherein
a plurality of the air blowing means are provided to be arranged along a locus of movement of the sheet holding means in accordance with rotation of the transport cylinder.

6. The drying apparatus for a sheet according to claim 2, wherein
the sheet guide members are supported to be movable in the axial direction of the transport cylinder.

7. The drying apparatus for a sheet according to claim 1, wherein
the drying means is supported to be movable in an axial direction of the transport cylinder.

8. The drying apparatus for a sheet according to claim 7, wherein
the drying means can be detached laterally of the transport cylinder.

9. The drying apparatus for a sheet according to claim 1, wherein
the transport cylinder is rotatably supported by a frame, and
the drying means is supported not to be rotatable with respect to the frame.

10. The drying apparatus for a sheet according to claim 1, wherein
the transport cylinder comprises a pair of hollow shaft members rotatably supported by a pair of frames, a connecting member supported between the pair of hollow shaft members and constituting the sheet holding means, and drive transmission means provided on at least one of the pair of shaft members for transmitting drive to the transport cylinder, and
the drying means is provided between the pair of shaft members, and opposing the printed surface or the coated surface of the sheet held by the sheet holding means of the transport cylinder to dry the printed surface or the coated surface of the sheet.

11. The drying apparatus for a sheet according to claim 1, wherein
the drying means is a UV lamp for drying the printed surface or the coated surface of the sheet, and
a cover having an opening on a side of the UV lamp opposing the printed surface or the coated surface of the sheet is provided.

12. The drying apparatus for a sheet according to claim 7, further comprising:
a first guide member fixed to a frame side and extending along the axial direction of the transport cylinder;
a second guide member fixed to the drying means, which dries the printed surface or the coated surface of the sheet, and extending along the axial direction of the transport cylinder; and
a third guide member engaging the first guide member and the second guide member, extending along the axial direction of the transport cylinder, supported by the first guide member, and supporting the second guide member.

13. The drying apparatus for a sheet according to claim 1, further comprising:
air ejection means provided along a locus of movement of the sheet holding means in accordance with rotation of the transport cylinder, and adapted to eject air toward opposite end portions, in an axial direction of the transport cylinder, of the sheet transported by the transport cylinder.

14. The drying apparatus for a sheet according to claim 1, further comprising:
heat release means for releasing heat generated within the transport cylinder to an outside.

15. The drying apparatus for a sheet according to claim 1, wherein
the transport cylinder is rotatably supported by a frame, and
the drying means is supported to be rotatable, where necessary, with respect to the frame independently of rotation of the transport cylinder.

16. The drying apparatus for a sheet according to claim 1, further comprising:
interference prevention means which moves the drying means from a position in proximity to the sheet to a position spaced from the sheet in a radial direction of the transport cylinder when the drying means opposes the sheet holding means of the transport cylinder, thereby preventing interference of the drying means with the sheet holding means.

17. The drying apparatus for a sheet according to claim 1, further comprising:
a sheet guide member opposing the transport cylinder and provided along a locus of movement of the sheet holding means of the transport cylinder to guide the sheet transported by the transport cylinder; and
sheet moving means for bringing the sheet transported by the transport cylinder into contact with an outer peripheral surface of the sheet guide member.

18. The drying apparatus for a sheet according to claim 17, wherein
the sheet moving means is air blowing means provided within the transport cylinder, and
the air blowing means opposes the sheet guide member and ejects air toward the sheet guide member, thereby bringing the sheet held by the sheet holding means into contact with the outer peripheral surface of the sheet guide member.
